(19) United States
(12) Patent Application Publication
(10) Pub. No.: US 2009/0028072 A1
(43) Pub. Date: Jan. 29, 2009

(54) IP Phone System Under Universal Plug and Play Protocol

(75) Inventor: WEI-KUO LIANG, Taipei (TW)

Correspondence Address: APEX JURIS, PLLC, 12360 LAKE CITY WAY NORTHEAST, SUITE 410, SEATTLE, WA, 98125, US

(73) Assignee: WISTRON CORP., Taipei Hsien (TW)

(21) Appl. No.: 11/866,206

(22) Filed: Oct. 2, 2007

(30) Foreign Application Priority Data
Jul. 27, 2007 (TW) 096127392

(51) Int. Cl. H04L 12/16

(52) U.S. Cl. 370/271

(57) ABSTRACT

An IP phone system is connected to an IP phone board and used for communicating with an UPnP devices under Universal Plug and Play (UPnP) Protocol. The UPnP device is provided with a device end digital media server and a device end digital media player. The IP phone system comprises an IP phone interface used for receiving AV data transmitted from an IP phone board, an AV converter used for converting the AV data from conforming to a Digital Living Network Alliance (DLNA) type to conforming to an IP phone type and vice versa, a phone end digital media server connected to the AV converter and transmitting the converted AV data to the device end digital media player and a phone end digital media player receiving the AV data transmitted from the device end digital media server, connected to the AV converter and transmitting the converted AV data to the IP phone board.

### CROSS-REFERENCES TO RELATED APPLICATIONS

This non-provisional application claims priority under 35 U.S.C. §119(a) on Patent Application No(s). 096127392 filed in Taiwan, R.O.C. on Jul. 27, 2007 the entire contents of which are hereby incorporated by reference.

### FIELD OF INVENTION

The present invention relates to an IP phone system, and more particularly to a IP phone system under Universal Plug and Play (UPnP) Protocol.

### BACKGROUND

Digital Living Network Alliance (DLNA) is an alliance organization constituted by multiple of electronic devices comprising consumer electronics and IP phone, computer manufacturers and etc. The main object of the alliance organization is to build an industrial standard to allow products of each manufacturer to be connected with one another, accommodated to one another and further to enable a consumer to achieve a digitized living.

Under a structure of DLNA, aspects concerning discovery, control and media management of devices are achieved by means of UPnP Protocol, in which UPnP is a protocol published by UPnP Forum. An object of UPnP is that seamless mutual connection and mutual operation can be attained when each electronic facility in home network obeys the protocol. It is simply to say that the largest visionary of UPnP is to hope that all other devices on internet can know immediately that there is a new device to be added in once any device (for example, television, computer, stereo, refrigerator, alarm clock, light and etc) is connected to internet, and these devices can be communicated with one another and can directly be used or controlled; nothing is needed to set and the new device completely is “plug and play”. A corresponding patent such as Taiwan paten application No. 92115385 entitled as “virtue remote controlling system and method by means of technology of UPnP under wireless LAN” mainly introduce that executing a UPnP “virtue remote controlling facility” on a home computer allows a tablet PC and a PDA connected together through wireless or wiring network to control functions provided by the home computer by manipulating “virtue remote controlling facility”.

Besides, there is still another communication protocol concerning IP phone called as Voice over Internet Protocol (VoIP). VoIP is a recent fast-developed technology; after analog signals of voices are digitized, they are compressed to a type of data packet to transmit over Internet. And then, the data packet is decompressed to return to analog voice signals to attain to the end-to-end real-time communication function through Internet. A corresponding patent such as Taiwan Patent Application No. 94100166 entitled as “Globalization communication IP phone system” mainly introduces a system used for Internet communication transmission on a computer web page, it adds a signature file in an electronic mailbox and the signature file is used to connect to a specific web page to proceed a VoIP communication with another party.

As VoIP can not only provide a voice transmission service but also transmit integrated content such as data and video together with VoIP is transmitted through Internet, call charges is much cheaper than general telephone charges. Therefore, the market pays much attention to the IP phone day by day.

However, making a comprehensive survey of the current electronic products, there is no combination of the concept of DLNA and IP phone for them. Thus, a substantial IP phone is still needed when a phone call comes in and a person must stand by the IP phone and can then listen to the phone call and make a phone call. Thereupon, the convenience generated from UPnP Protocol is not actually brought into full play.

### SUMMARY

Seeing this, the present invention proposes an IP phone system under UPnP protocol. UPnP protocol in DLNA is used to combine with an IP phone. Thus, it is unnecessary to be provided with a traditional IP phone, and each module of the traditional IP phone such as display, speaker, microphone, camera or input facility is built in a digital home appliance such as television, stereo, refrigerator, computer or multimedia storage device. A substantial line of communication originally used for connecting these modules of the IP phone is changed to a connection through a wiring or wireless network by means of UPnP to transmit AV data of DLNA protocol. Therefore, an incoming phone call can be listened through any connected home appliance in the digital living network, and the connected appliance can be used as intercoms to communicate with each other.

The present invention proposes an IP phone system connected to an IP phone board is used for communicating with a UPnP device under UPnP protocol. The UPnP device is provided with a device end digital media server and device end digital media player,. The IP home system comprises an IP phone interface used for receiving AV data transmitted from the IP phone board, an AV converter used for converting AV data to conform to one of DLNA and IP phone types, a phone end digital media server connected to the AV converter and sending the converted AV data to a device end digital media player and a phone end digital media player used for receiving the AV data transmitted from the device end digital media server, connected to the AV converter and sending the converted AV data to the IP phone board.

The present invention also proposes an IP phone system used for connecting first AV data to second AV data under UPnP Protocol. The IP phone system comprises an IP phone board, an IP phone interface connected to the IP phone board and used for receiving the first AV data transmitted from the IP phone board, an AV converter used for converting the first AV data and the second AV data to conform to one of DLNA and IP phone types, a phone end digital media server connected to the AV converter and transmitting the converted first AV data, a device end digital media player used for playing the first AV data transmitted from the phone end digital media server, a device end digital media server used for transmitting the second AV data depending on the first AV data, a phone end digital media player used for receiving the second AV data transmitted from the device end digital media server, connected to the AV converter and transmitting the converted second AV data to the IP phone board.

The present invention also proposes an IP phone system applied to UPnP Protocol, the IP phone system comprises a first device end digital media server used for transmitting a first AV data, a second device end digital media player used for playing the first transmitted from the first device end digital media server, a second device end digital media server used for transmitting second AV data depending on the first AV data and a first device end digital media player used for playing the second AV data transmitted from the second device end digital media server.

### BRIEF DESCRIPTION OF THE DRAWINGS

The present invention can be more fully understood by reference to the following description and accompanying drawings, in which:

FIG. 1 is a block diagram, showing an IP phone system of a first preferred embodiment according to the present invention;

FIG. 2 is a block diagram, showing an IP phone system of a second preferred embodiment according to the present invention; and

FIG. 3 is a block diagram, showing an IP phone system of a third preferred embodiment according to the present invention.

### DETAILED DESCRIPTION

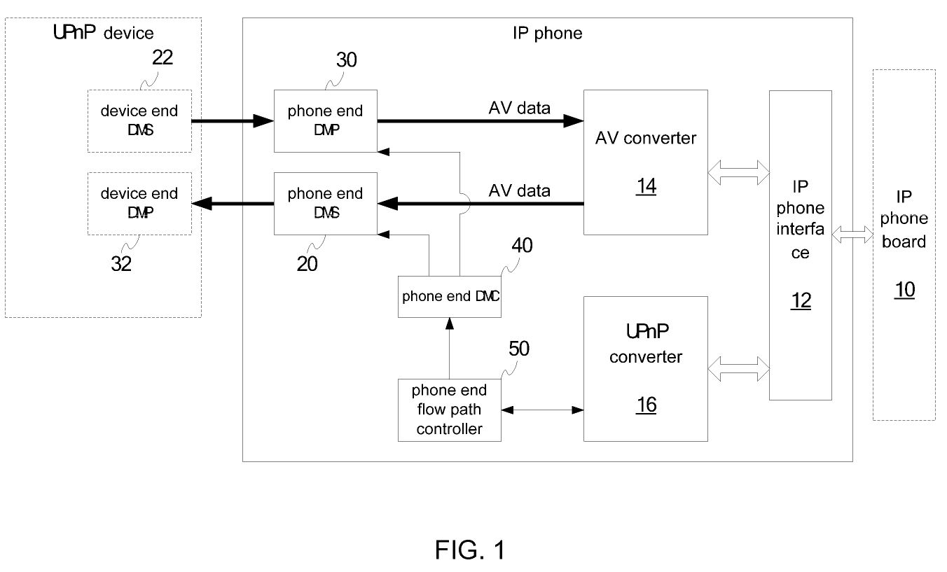

Please refer to FIG. 1. FIG. 1 is a block diagram, showing an IP phone system of a first preferred embodiment according to the present invention. The IP phone system of the first embodiment connected to an IP phone board 10 is used for communicating with a UPnP device under UPnP Protocol, and the UPnP device is provided with a device end digital media server (“device end DMS” for short thereinafter) 22 and a device end digital media player (“device end DMP” for short thereinafter) 32. Furthermore, the IP phone system of the first embodiment mainly comprises an IP phone interface 12, an AV converter 14, a phone end digital media server (“phone end DMS” for short thereinafter) 20 and a phone end digital media player (“phone end DMP:” for short thereinafter) 30.

The IP phone system of the present invention is connected to the IP phone board 10 which is the only most basic IP phone element left after many modules such as display, speaker, microphone, camera and input facility are withdrawn from a traditional IP phone. Thus, the IP phone system of the present invention is unnecessary to be provided with the traditional IP phone and only necessary to be connected to the basic element of the IP phone.

As IP phone has been developed for many years, there are many manufacturers put it into development and production such that different specifications exist among the manufacturers. Thus, for providing a platform to communicate with an application programming interface (API) of each manufacturer's IP phone, the present invention is provided with an IP phone interface 12 for being connected to the IP phone board 10 and taken as an interface communicating with the IP phone board 10 and in the meantime, the IP phone interface 12 is also used for receiving AV data transmitted from the IP phone board 10.

As the IP phone system of the present invention is applied under UPnP Protocol, AV data under the protocol must conform to a type of DLNA. However, AV data transmitted from the IP phone board 10 conforms to a type of IP phone but does not conform to the type of DLNA such that they cannot be used by devices in UPnP Protocol. Thus, the AV converter 14 may convert AV data transmitted into the IP phone board 10 through the IP phone interface 12 into a DLNA type capable of being accepted by the phone end DMS 22. Similarly, the AV converter 14 may also convert DLNA type AV data transmitted from the device end DMS 22 into an IP phone type and then sends the IP phone type AV data to the IP phone board 10. Thus it can be seen that the main function of the AV converter 14 is converting AV data into data conforming to one of DLNA and IP phone types. Besides, because each IP phone manufacturer's product is provided with a different specification, the IP phone interface 12 is provided as a platform for communicating each IP phone manufacturer with one another.

The phone end DMS 20 and the device end DMS 22 proposed in the present invention all belong to digital media server (DMS) in the DLNA structure, the difference is that the former is disposed at the phone end and the latter is disposed at the device end, in which the main role played by the digital media server is a source device used for providing digital media files, obtaining stream, recording, storing and etc. Relatively, no matter what it is the phone end DMP 30 or the device end DMP 32, they all belong to digital media player (DMP) in the DLNA structure, in which the main role played by the digital media player is an output device used for searching and playing/outputting any digital media file and stream provided by the DMS.

In the first embodiment, the phone end DMS 20 is connected to the AV converter 14. AV data conforming to the IP phone type is converted to the one conforming to the DLNA type after being converted by the AV converter 14. At this time, the converted AV data is then sent to the device end DMP 32. Up to the present, a UPnP device has already received and output the AV data sent from the IP phone board 10 through the device end DMP 32.

Next, the UPnP device sends an AV data that wants to answer the IP phone board 10 through the device end DMS 22 to the phone end DMP 30, the phone end DMP 30 receives the AV data sent from the device end DMS 22 and is connected to the AV converter 14. After the AV converter 14 receives the AV data, it will convert the AV data conforming to DLNA type to AV data conforming to IP phone type. Thereafter, the AV converter 14 sends the converted AV data to the IP phone board 10. Up to the present, the UPnP device has already sent the answering AV data to the IP phone board 10 through the device end DMS 22 and the phone end DMP 30 and in the meantime, the answering AV data are output/played through the phone end DMP 30.

The IP phone system of the first embodiment may further comprises a phone end digital media controller (“phone end DMC” for short thereinafter”) 40, in which the main function of the DMC is a connection bridge between the DMS and DMP; the DMC can search multimedia files on the DMS, and appoint the DMP capable of playing the multimedia files to proceed playing or control the multimedia files to upload or download to the DMS device. Here, the phone end DMC 40 connects the phone end DMS 20 to the phone end DMP 30, and issues an command to request a connection between the phone end DMS 20 and the device end DMP 32 as well as a connection between The phone end DMP 30 and the device end DMS 22. Furthermore, after the phone end DMS 20 and the phone end DMP 30 are respectively connected to the device end DMP and the device end DMS 22, the AV data can then be transmitted to each other to attain to the mutual communication between the phone end and the device end.

The IP phone system of the first embodiment may further comprise a UPnP converter 16 used for converting an event conforming to the UPnP type to an event conforming to the IP phone type and vice versa, in which the event called here may be a phone end event sent from the IP phone board 10 or a device end event sent from the UPnP device.

That is to say, the UPnP converter 16 is similar to the AV converter 14, the difference is that the AV converter 14 converts AV data conforming to the DLNA type to the one conforming to the IP phone type and vise versa, and the UPnP converter 16 converts a device end event (UPnP type) sent from the UPnP device to the one conforming to the IP phone type, and sends it to the IP phone board 10 through the IP phone interface 12.

Besides, the IP phone system of the first embodiment may further comprise a phone end flow path controller 50 used for controlling an operation flow path of the event in the whole IP phone system. Thereinafter, aiming at a phone end event, taking incoming phone call broadcasting as an example to describe, functions of the flow path controller 50 can be clearly understood from the example.

First, when the IP phone board 10 receives an incoming phone call, it emits a phone end event (i.e. incoming phone call event) through an application program interface (API, not shown in the figure) thereof. At this time, the IP phone interface 12 receives the phone end event sent from the IP phone board 10 and sends the received phone end event to the UPnP converter 16 by means of the control of the IP phone interface 12.

After the UPnP converter 16 converts the received phone end event to an event conforming to the UPnP type, and transmits the phone end event to the phone end flow path controller 50 to be processed there. At this time, the phone end flow path controller 50 issues an command, and the main content of the command is requesting the phone end DMC to release an incoming phone call message to the device end DMP 32 in all UPnP devices via the phone end DMS 20.

Thereupon, the phone end DMC 40 controls the phone end DMS 20 after it receives the command. The phone end DMS 20, finally, sends the incoming phone call message to all event receivable device end DMP 32. The incoming phone message can then be broadcasted to all the UPnP devices after the aforementioned steps are passed through.

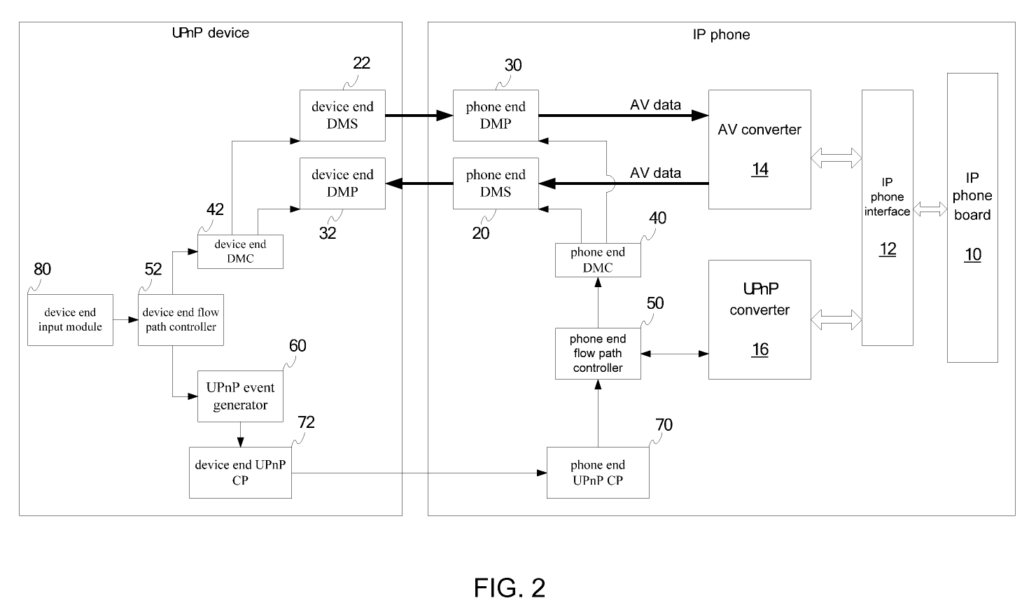

Please refer to FIG. 2. FIG. 2 is a block diagram showing an IP phone system of a second preferred embodiment according to the present invention. The second embodiment is similar to the first embodiment except that the second embodiment brings a part of elements of a UPnP device end into it. An IP phone system of the second embodiment comprises an IP phone board 10, an IP phone interface 12, an AV converter 14, a phone end DMS 20, a device end DMP 32, a device end DMS 22 and a phone end DMP 30.

Similarly, the IP phone system of the second embodiment is used under UPnP Protocol and capable of being used for communicating with first AV data and second AV data. The IP phone interface 12 is connected to the IP phone board 10 and used for receiving the first AV data transmitted from the IP phone board 10. The AV converter 14 converts the first AV data and the second AV data form conforming to the DLNA type to conforming to the IP phone type and vice versa. The phone end DMS 20 is connected to the AV converter 14 and used for sending the converted first AV data. The device end DMP 32 is used for playing the first AV data transmitted from the phone end DMS 20.

Next, the device end DMS 22 transmits the second AV data depending on the first AV data, in which the second AV data are AV data used for answering the first AV data. Finally, the phone end DMP 30 receives the second AV data transmitted from the device end DMS 22 and is connected to the AV converter 14 as well as transmits the converted second AV data to the IP phone board 10.

For example, when two persons A and B want to use IP phones to communicate with each other, in which the person A uses the IP phone system proposed by the present invention as FIG. 2 shows, and the person B uses a general AV data transmittable IP phone. First, the person B uses an IP phone (not shown in the figure) to make a phone call to the person A so that the person B first sends a first AV data out and at this time, the person A receives the first AV data through the IP phone board 10 and the IP phone interface 12, and then sent the first AV data to the device end DMP 32 through the AV converter 14 and the phone end DMS 20, and at this time, the person A has already received the first AV data transmitted from the person B. Next, the person A may send a second AV data for answering the person B to the phone end DMP 30 through the device end DMS 22 and then send the second AV data to the person B via the AV converter 14, the IP phone interface 12 and the IP phone board 10.

The IP phone system of the second embodiment may further comprise a digital media controller (‘device end DMC” for short thereinafter) 42. The device end DMC 42 and the phone end DMC 40 all belong to a digital media controller (DMC) in the DLNA structure, in which the main role played by the digital media controller is a connection bridge between the DMS and the DMP; the DMC may search multimedia files on the DMS and appoints the DMP capable of playing multimedia files to proceed playing or controls the multimedia file to upload/download to the DMS device. In the second embodiment, the device end DMC 42 is connected to the device end DMS 22 and the device end DMP 32, and used for controlling a connection of the device end DMS 22 and the phone end DMP 30 as well as a connection of the device end DMP 32 and the phone end DMS 20.

The IP phone system of the second embodiment may further comprise a device end flow path controller 52, a UPnP event generator 60, a device end UPnP control point (“device end UPnP CP” for short thereinafter) 72 and a phone end UPnP control point (“phone end UPnP CP” for short thereinafter) 70, in which after the device end flow path controller 52 receives a device end event, it controls operation steps of the device end event in the whole IP phone system. Thereinafter, there is a more detailed description concerning the device end event.

The UPnP event generator 60 receives the device end event transmitted from the device end flow path controller 52 and converts the device end event to an event conforming to the UPnP type. The phone end UPnP CP 70 and the device end UPnP CP 72 belong to a controller of UPnP protocol, and functions thereof are similar to a remote controller; they can be used for receiving and sending out an command. In the second embodiment, the device end UPnP CP 72 receives and sends the device end event converted by the UPnP event generator 60. And then, the device end event transmitted from the device end UPnP CP 72 is received through the phone end UPnP CP 70. That is to say, the device end and the phone end may send events and commands to each other through the device end UPnP CP 72 and the phone end UPnP CP 70 to attain to the communication and contact between the device end and the phone end.

Besides, the IP phone system of the second embodiment further comprises a device end input module 80, in which the device end input module 80 allows a user to input a device end event. The device end event here may be an incoming phone call listening or an outside phone call making. Thereinafter, the two device end events mentioned here are respectively described as the following.

First, a condition that the device end event is an incoming phone call listening is described. This event is the answering condition of the incoming phone call broadcasting event introduced previously. When a user inputs a listening event through the device end input module 80, a listening command is sent out after the listening event is processed through the device end flow path controller 52. The listening command sent from the device end flow path controller 52 is received through the UPnP event generator 60 and in the meantime, the listening event is converted to an event conforming to the UPnP type through the UPnP event generator 60. Thereafter, the listening event is sent to the phone end UPnP CP 70 via the device end UPnP CP 72.

Next, after the phone end flow path controller 50 receives the event transmitted from the phone end UPnP CP 70, it starts processing the event. The phone end flow path controller 50 sends the event to the UPnP converter 16, and the event is sent to the IP phone board 10 through the IP phone interface 12 after the event is converted to an event conforming to the UPnP type. After an answer from the IP phone board 10 is received, it returns back to the phone end flow path controller 50 via the IP phone interface 12 and the UPnP converter 16. At this time, the phone end flow path controller 50 will request the phone end DMS 20 to connect with the device end DMP 32 and the device end DMS 22 to connect with the phone end DMP 30 through the phone end DMC 40.

The connection operation of the phone end and the device end is completed after the aforementioned steps. And then, the phone end DMS 20 and the device end DMP 32 as well as the device end DMS 22 and the phone end DMP 60 transmit the AV data to each other through the AV converter 14 to attain to the AV communication between the phone end and the device end.

Here, it must first be explained that “connection” stated in the present invention is not limited to a substantial wiring connection; it may also be a wireless connection allowing signals, data and etc to be transmitted between elements.

Another device end event is the outside phone call making, the flow paths of this event and the aforementioned incoming phone call listening are almost the same, the difference is that an event input by a user in the beginning through the device end input module 80 is outside phone call making, and other steps are the same as the processing steps of the aforementioned incoming phone call listening event.

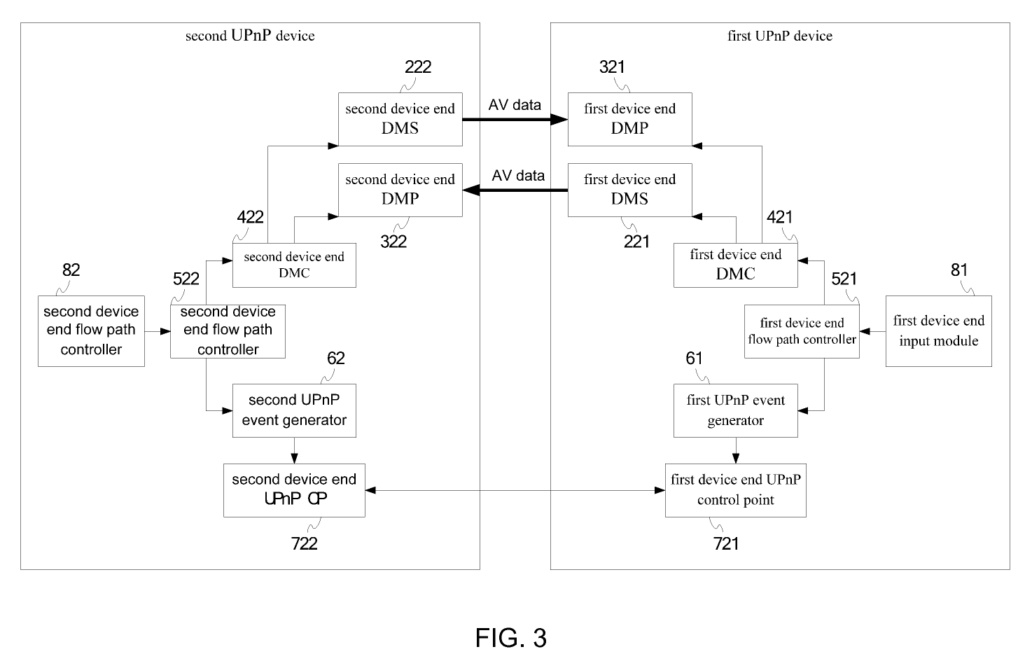

Please refer to FIG. 3. FIG. 3 is a block diagram showing an IP phone system of a third preferred embodiment according to the present invention. In the IP phone system of the third embodiment according to the present invention, each UPnP device can be used as an intercom. The IP phone system of the third embodiment is similarly applied under UPnP Protocol and comprises a first device end digital media server (“first device end DMS” for short thereinafter) 221, a first device end digital media player (“first device end DMP” for short thereinafter) 321, a second device end digital media server (“second device end DMS” for short thereinafter) 222 and a second device end digital media player (“second device end DMP” for short thereinafter) 322.

The first device end DMS 221 sends out first AV data, and the second device end DMP 322 plays the first AV data transmitted from the first device end. And then, the second device end DMS 222 will send out a second AV data depending on the first AV data; the second AV data is similar to the aforementioned second AV data, it is also AV data used for answering the first AV data. Finally, the first device end DMP 321 will play the second AV data answered by the second device end DMS 222.

The IP phone system of the third embodiment further comprises a first device end digital media controller (“first device end DMC” for short thereinafter) 421, a second end digital media controller (“second device end DMC” for short thereinafter) 422, a first device end flow path controller 521, a second device end flow path controller 522, a first UPnP event generator 61, a second UPnP event generator 62, a first device end UPnP control point (“first device end UPnP CP) 721, a second device end UPnP control point (“second device end UPnP CP) 722, a first device end input module 81 and a second device end input module 82.

Functions of each element mentioned right above are similar to the functions of the corresponding element of the first or the second embodiment; an event is directly taken to explain in the following. In the third embodiment, the event may be a mutual communication and may emit from the first device end or the second device end.

After a user inputs a first device end event (mutual communication) through the first device end input module 81 and the first device end flow path controller 521 receives the mutual communication event, the first device end flow path controller 521 then controls an operation flow path of the mutual communication event in the whole IP phone system. First, the event is transmitted to the first UPnP event generator 61 by means of a circuit control of the first device end flow path controller 521 to convert the event to an event conforming to the UPnP type. And then, the first device end UPnP CP 721 receives the converted event of the first UPnP event generator 61 and sent the event to the second device end UPnP CP 722. Up to the present, the second device end has already received the mutual communication event requested by the first device end and in the meantime, the first device flow path controller 521will emit a signal to the first device end DMC 421 after it knows that the second end has already received the event.

Next, an command is sent out through the first device end DMC 421; it is used for requesting a connection of the first device end DMS 221 and the second device end DMP 322 as well as a connection of the first device end DMP 321 and the second device end DMS 222. Furthermore, after the first device end DMS 221 and DMP 321 mentioned above are respectively connected to the second device end DMP 322 and DMS 222, the AV data can then transmitted to each other to attain to the mutual communication between the first device end and the second device end.

similarly, a user may also input a second device end event (mutual communication as well) through the second device end input module 82, and a flow path thereof is the same as the flow path mentioned above, the detailed description thereof is omitted here.

It can be known from the description mentioned above that it only needs to remain the most basic element (IP phone board) in the traditional IP phone, withdraw all other elements thereof and then use UPnP device in the DLNA structure by means of the IP phone system proposed by the present invention; the communication can be proceeded. Whereby, the following advantages can be acquired:

1. it is unnecessary to equip with multiple phones in a home.

2. a phone call is not missed even if nobody is beside the phone.

3. a communication can be proceeded anytime and any place through a digital home appliance, i.e. UPnP device such as television, stereo, refrigerator, computer or multimedia storage device.

4. there is a capability of adding values to a digital home appliance.

5. each digital home appliance may be used as an intercom.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An IP phone system, connected to an IP phone board and used for communicating with an UPnP device under Universal Plug and Play (UPnP) Protocol, the UPnP device being provided with a device end digital media server and a device end digital media player, the IP phone system comprising:
an IP phone interface, used for receiving AV data transmitted from the IP phone board;
an AV converter, converting the AV data to AV data from conforming to a Digital Living Network Alliance (DLNA) type to conforming to an IP phone type and vice versa;
a phone end digital media server, connected to the AV converter, and transmitting the converted AV data to the device end digital media player; and
a phone end digital media player, receiving the AV data transmitted from the device end digital media server, connected to the AV converter and transmitting the converted AV data to the IP phone board.

2. The system according to claim 1, further comprising:
a phone end digital media controller, connected to the phone end digital media server and the phone end digital media player, and used for controlling connections of the phone end digital media server and the device end digital media player as well as the phone end digital media player and the device end digital media server.

3. The system according to claim 1, further comprising:
an UPnP converter, converting an event from conforming to the UPnP type to conforming to the IP phone type and vice versa.

4. The system according to claim 3, further comprising:
a phone end flow path controller, receiving the converted event and used for controlling a flow path of the event.

5. An IP phone system, adapted to transmit a first AV data and a second AV data under UPnP Protocol, the IP phone system comprising:
an IP phone board;
an IP phone interface, connected to the IP phone board and used for receiving the first AV data transmitted from the IP phone board;
an AV converter, converting the first AV data and the second AV data from conforming to a DLNA type to conforming to an IP phone type and vice versa;
a phone end digital media server, connected to the AV converter and sending out the converted first AV data;
a device end digital media player, playing the first AV data transmitted from the phone end digital media server;
a device end digital media server, sending out the second AV data depending on the first AV data; and
a phone end digital media player, receiving the second AV data transmitted from the device end digital media server, connected to the AV converter and transmitting the converted second AV data to the IP phone board.

6. The system according to claim 5, further comprising:
a phone end digital media controller, connected to the phone end digital media server and the phone end digital media player, and used for controlling connections of the phone end digital media server and the device end digital media player as well as the phone end digital media player and the device end digital media server.

7. The system according to claim 6, further comprising:
a device end digital media controller, connected to the device end digital media server and the device end digital media player and used for controlling connections of the device end digital media server and the phone end digital media player as well as the device end digital media player and the phone end digital media server.

8. The system according to claim 6, further comprising:
an UPnP converter, converting an event from conforming to the UPnP type to conforming to the IP phone type and vice versa.

9. The system according to claim 8, further comprising:
a phone end flow path controller, receiving the converted event and used for controlling a flow path of the event.

10. The system according to claim 7, further comprising:
a device end flow path controller, receiving a device end event, and used for controlling a flow path of the device end event.

11. The system according to claim 10, further comprising:
an UPnP event generator, receiving the device end event transmitted from the device end flow path controller and converting the device end event to conform to a UPnP type.

12. The system according to claim 11, further comprising:
a device end UPnP control point, receiving and sending out the device end event converted by the UPnP event generator; and
a phone end UPnP control point, receiving the device end event transmitted from the device end UPnP control point.

13. The system according to claim 7, further comprising:
a device end input module, allowing a user to input a device end event.

14. An IP phone system, applied under UPnP protocol, the IP phone system comprising:
a first device end digital media server, transmitting a first AV data;
a second device end digital media player, playing the first AV data transmitted from the first device end digital media server;
a second device end digital media server, transmitting a second AV data depending on the first AV data; and
a first device end digital media player, playing the second AV data transmitted from the second device end digital media server.

15. The system according to claim 14, further comprising:
a first device end digital media controller, connected to the first device end digital media server and the first device end digital media player and used for controlling connections of the first device end digital media server and the second device end digital media player as well as the first device end digital media player and the second device end digital media server.

16. The system according to claim 15, further comprising:
a second device end digital media controller, connected to the second device end digital media server and the second device end digital media player and used for controlling connections of the second device end digital media server and the first device end digital media player as well as the second device end digital media player and the first device end digital media server.

17. The system according to claim 15, further comprising:
a first device end flow path controller, receiving a first device end event, and used for controlling a flow path of the first device end event.

18. The system according to claim 17, further comprising:
a first UPnP event generator, receiving the first device end event transmitted from the first device end flow path controller and converting the first device end event to conform to a UPnP type.

19. The system according to claim 18, further comprising:
a first device end UPnP control point, receiving and sending out the first device end event converted by the first UPnP event generator; and
a second device end UPnP control point, receiving the first device end event transmitted from the first device end UPnP control point.

20. The system according to claim 16, further comprising:
a second device end flow path controller, receiving a second device end event, and used for controlling a flow path of the second device end event.

21. The system according to claim 20, further comprising:
a second UPnP event generator, receiving the second device end event transmitted from the second device end flow path controller and converting the second device end event to conform to a UPnP type.

22. The system according to claim 21, further comprising:
a second device end UPnP control point, receiving and sending out the second device end event converted by the second UPnP event generator; and
a first device end UPnP control point, receiving the second device end event transmitted from the second device end UPnP control point.

23. The system according to claim 17, further comprising:
a first device end input module, allowing a user to input a first device end event.

24. The system according to claim 20, further comprising:
a second device end input module, allowing a user to input a second device end event.
